(19) United States
(12) Patent Application Publication
(10) Pub. No.: US 2012/0282496 A1
(43) Pub. Date: Nov. 8, 2012

(54) FRAME FOR AN ELECTROCHEMICAL ENERGY STORAGE DEVICE

(75) Inventor: Tim Schaefer, Harztor (DE)

(73) Assignee: Li-Tec Battery GmbH, Kamenz (DE)

(21) Appl. No.: 13/521,933

(22) PCT Filed: Dec. 16, 2010
(86) PCT No.: PCT/EP2010/007719

§ 371 Date: Jul. 12, 2012

(30) Foreign Application Priority Data
Jan. 13, 2010 (DE) 10 2010 004 471.7

(51) Int. Cl. H01M 2/10; H01M 10/42

(52) U.S. Cl. 429/7; 429/100; 429/99; 429/50

(57) ABSTRACT

The invention relates to a frame (1) for an electrochemical energy storage device (2), wherein the frame (1) is intended to enclose the electrochemical energy storage device (2) at least in some areas and comprises a frame element (3) which includes a first frame element area (5) having a first yield point. Said frame is characterized in that it comprises a second frame element area (6) having a second yield point and in that the quotient of the yield points of the second frame element area (6) and the first frame element area (5) lies below a predetermined value.

The present invention relates to a frame for an electrochemical energy storage device, to a battery cell comprising this frame and an electrochemical energy storage device, to a battery comprising at least one such battery cell, to a motor vehicle comprising a battery according to the invention, and to two operating methods. The invention will be described in the context of lithium-ion batteries for powering motor vehicle drives. It is pointed out that the invention can also be used independently from the type of the battery or independently of the type of the drive that is powered.

Batteries for powering motor vehicle drives are known from the prior art. Some designs have in common that the surroundings of these batteries are placed at risk as a result of damage to these batteries, for example during an accident of a motor vehicle that is powered by the battery.

It is therefore the object of the invention to reduce the risk of the surroundings by a damaged battery, for example during an accident of a motor vehicle powered by the battery.

This is achieved according to the invention by the teaching of the independent claims. Refinements of the invention to be preferred are the subject matter of the dependent claims.

A frame according to the invention is provided for one, two or more electrochemical energy storage devices. The frame is notably provided to surround the at least one electrochemical energy storage device at least in some regions, preferably along several delimiting edges of the electrochemical energy storage devices. The frame comprises at least one frame element, and preferably two to four frame elements. A frame element comprises a first frame element region having a first yield point. The frame is characterized by a second frame element region, which is associated in particular with a frame element. According to the invention, the second frame element region has a second yield point. According to the invention, the quotient q of the yield points of a second frame element region and a first frame element region falls below a predetermined value.

Within the meaning of the invention, a frame shall be understood to mean a device which is used in particular to surround an electrochemical energy storage device, at least in some regions. The frame comprises a receiving region or frame opening for one, two or more electrochemical energy storage devices. The frame preferably surrounds an electrochemical energy storage device along at least two of the delimiting edges thereof, which are arranged parallel to each other. The frame still more preferably continuously surrounds an electrochemical energy storage device. The frame is preferably designed as a thin-walled plate having a first and a second primary extension direction and two parallel primary planes. The receiving region is preferably adapted to the shape of the electrochemical energy storage device to be accommodated. The frame preferably surrounds the electrochemical energy storage device at a predetermined distance. The frame preferably comprises two substantially parallel delimiting surfaces. The frame is preferably designed as a solid body. The receiving region of the frame preferably accommodates two or more electrochemical energy storage devices.

The thickness of the frame is preferably greater than the thickness of the accommodated electrochemical energy storage devices.

Within the meaning of the invention, an electrochemical energy storage device shall be understood to mean a device which is notably used to deliver electrical energy and to convert stored chemical energy into electrical energy. The electrochemical energy storage device comprises at least one electrode stack having a plurality of anodes and cathodes (electrodes), wherein a respective anode and cathode are separated by a separator. The electrochemical energy storage device further comprises two current collectors having differing polarities, each being electrically connected to one of the electrodes. The electrochemical energy storage device preferably has a plate-shaped design having a first and a second primary extension direction. The electrochemical energy storage device is preferably designed as a flat cuboid having two parallel largest delimiting surfaces, two pairs of smaller delimiting surfaces that are parallel to each other, and eight delimiting edges of the delimiting surfaces. A current collector preferably extends out of a smaller delimiting surface. The current collectors having differing polarities preferably extend from the same smaller delimiting surface of the electrochemical energy storage device. An electrochemical energy storage device is preferably secured against shifting inside the opening of the frame by at least one spacer which is integrally molded on or inserted in the frame. The electrochemical energy storage devices are preferably rechargeable. The separator preferably comprises an electrolyte, in particular containing lithium.

Within the meaning of the invention, a frame element shall be understood to mean a component of the frame, wherein the frame element extends along one of the primary extension directions of the electrochemical energy storage device. A frame element is preferably designed as a spar.

A frame element is preferably dimensioned at least as long as the associated adjoining delimiting edge of the electrochemical energy storage device. A frame element is preferably designed as a solid body. The frame preferably comprises two, and still more preferably four, frame elements, wherein two respective frame elements are arranged parallel to each other. According to the invention, a frame element comprises two substantially parallel delimiting surfaces. These parallel delimiting surfaces preferably coincide with the two largest delimiting surfaces of a plate-shaped replacement body which corresponds to the outside dimensions of the frame.

Within the meaning of the invention, a first frame element region shall be understood to mean a region of a frame element. A first frame element region is characterized by a first yield point. Inside a frame element, this first frame element region is preferably arranged adjacent to the electrochemical energy storage device and faces the same. The first frame element region preferably extends across the entire length of an adjoining delimiting edge of the electrochemical energy storage device. A first frame element region is preferably in particular a part of a frame element in terms of the material. The first yield point is preferably higher than the yield point of the electrochemical energy storage device. A first frame element region preferably comprises at least one material from the following group consisting of: ferruginous alloys, steel, lightweight metals such as aluminum, titanium or magnesium, plastic materials such as notably PP, PA or PE, which are in particular crosslinked and which are in particular reinforced with fillers and/or woven fabrics/laid scrims, notably containing glass fibers and/or aramide fibers. A first frame element region preferably has a honeycomb structure, still more preferably containing aramide fibers and/or a metal foil, wherein still more preferably the longitudinal axes of the honeycombs are arranged in the direction of the acting foreign body. A first frame element region preferably comprises a rib or ridge, which still more preferably extends in the primary plane of the frame.

Within the meaning of the invention, a yield point shall be understood to mean a property which notably provides information about the behavior of a body in response to an acting force. The yield point of a frame element region is defined by the material, the geometry of the frame element region and the type of load. The measure for the yield point is notably the elastic limit of a material of a frame element and/or notably the travel by which a surface of a frame element region upon which a force acts is displaced in the direction of force and/or in a transverse direction to this force. In a solid matter which is at least partially crystalline, the elastic limit of the material preferably serves as a measure of the yield point, in particular with a metal or a semi-crystalline polymer.

Within the meaning of the invention, a second frame element region shall be understood to mean an additional region of a frame, notably comprising frame elements. A second frame element region is notably characterized by a second yield point. A first frame element region is preferably part of a first frame element, and a second frame element region is preferably part of a second frame element. A second frame element region preferably extends along a primary extension direction of the associated electrochemical energy storage device. A frame element preferably comprises both a first frame element region and a second frame element region, wherein still more preferably the first frame element region is arranged at a smaller distance from the associated electrochemical energy storage device than a second frame element region. A first frame element region and a second frame element region preferably extend along differing primary extension directions of the associated electrochemical energy storage device. A second frame element region preferably comprises at least one material from the following group consisting of: lightweight metals such as aluminum, titanium or magnesium, non-crosslinked plastic materials, elastomers, gels, glass or sand particles, textile mats or laid scrims, foams, in particular made of steel, lightweight metals, and polymers, notably PU or PS. A second frame element region preferably has a honeycomb structure, wherein still more preferably the longitudinal axes of the honeycombs are arranged transversely to the acting foreign body. A second frame element region preferably has a shape which favors transverse strain of the second frame element region under an acting force. A second frame element region preferably has a wave profile and/or corrugations, the longitudinal axes of which are arranged transversely to the acting foreign body. A second frame element region preferably acts:

by preferably deforming under load and distributing an acting force across a large surface area,

by partially deflecting an acting force in the transverse direction thereof and/or

by converting an acting energy into heat, notably by means of dissipation.

According to the invention, the quotient q of the yield points g of the yield points g of the second frame element region and the first frame element region falls below a predetermined value q_{g}. The quotient q is calculated as follows:

$$q = \frac{{g}_{2}}{{g}_{1}} < {q}_{x}$$

The predetermined value of the quotient q_{g} is preferably less than 1, preferably less than 9/10, preferably less than 8/10, preferably less than 7/10, preferably less than 6/10, preferably less than 5/10, preferably less than 4/10, preferably less than 3/10, preferably less than 2/10, preferably less than 1/10, and preferably more than 1/100.

When designing the frame for an electrochemical energy storage device in accordance with the invention, high inherent stability is achieved, notably of a first frame element region. A rather resilient second frame element region acts as described above and thus reduces a damaging effect of an acting force on an electrochemical energy storage device. The scope of damage of a battery according to the invention, such as due to an accident, for example, and the risk for the surroundings, notably due to leaking chemicals, are thus reduced and the underlying problem is solved.

Preferred refinements of the invention will be described hereafter.

A first frame element region is advantageously arranged adjacent to a second frame element region. The first frame element region preferably is in contact with the second frame element region. A first frame element region can preferably be displaced with respect to a second frame element region. A first frame element region is preferably connected to a second frame element region of the same frame element, in particular bonded thereto, and still more preferably glued or welded thereto. The connection of a first frame element region to a second frame element region of a frame element is preferably implemented only in certain regions. A first frame element region is preferably arranged at a predetermined distance from a second frame element region of the same frame element. A first frame element region and a second frame element region preferably form differing layers of the same frame element. The cross-sections of these layers preferably have differing shapes.

The frame advantageously comprises one, two or more frame connecting regions. A frame connecting region is notably provided for the connection to an additional body. Such additional bodies notably include a cover of the frame opening and an adjoining frame of an additional battery cell. The cover is preferably connected, notably bonded, to the frame connecting region. A frame connecting region preferably comprises a cut-out which is notably used to pass through a connecting means. The connecting means is notably a device which connects several frames to each other, notably by way of a tie rod or strap. A frame preferably comprises a frame reinforcement component. Within the meaning of the invention, a frame reinforcement component shall be understood to mean a body which is characterized by high flexural rigidity, buckling rigidity and/or a high yield point. The yield point, flexural rigidity and buckling rigidly of the frame reinforcement component are preferably higher than the first yield point of a first frame element region. The frame preferably comprises several frame reinforcement components. A frame reinforcement component is preferably arranged adjacent to a first frame element region and is notably bonded thereto. A frame reinforcement component is preferably enclosed at least partially, and still more preferably is enclosed predominantly, by a first frame element region. A frame reinforcement component preferably extends across the entire length of a frame element. A frame reinforcement component, which is notably profiled, is preferably characterized by a high section modulus.

The frame advantageously comprises at least one frame cut-out, which is notably arranged on a frame element. The frame preferably comprises two or more frame cut-outs. The frame cut-out extends along or through a frame element and is notably used to accommodate a current collector of an electrochemical energy storage device. The current collector passes through this frame cut-out and extends through the frame cut-out beyond the frame element into the surroundings. A second frame element region is preferably interrupted in the region of a frame cut-out. A separating device is preferably arranged adjacent to the frame cut-out. The separating device is used in particular to sever a current collector that passes through or to strip a cell contact device.

According to the invention, a battery cell comprises a frame according to the invention and an electrochemical energy storage device. The frame surrounds the electrochemical energy storage device at least in some regions, preferably along several delimiting edges of the electrochemical energy storage device. The battery cell preferably comprises two or more electrochemical energy storage devices. Two electrochemical energy storage devices of a battery cell are preferably connected in series and/or in parallel.

The battery cell advantageously comprises a cell pressure distribution layer. The cell pressure distribution layer is used in particular to distribute, in a planar manner, a force or a pressure exerted by a foreign body on this cell pressure distribution layer. The cell pressure distribution layer notably separates the battery cell from a foreign body. A cell pressure distribution layer preferably comprises at least one material from the following group consisting of: ferruginous alloys, steel, lightweight metals such as aluminum, titanium or magnesium, in particular crosslinked plastic materials, plastic materials containing fillers and/or woven fabrics/laid scrims, notably containing carbon, glass and/or aramide fibers. A cell pressure distribution layer preferably has honeycomb structures, notably containing aramide fibers and/or a metal foil, wherein still more preferably the longitudinal axes of the honeycombs are arranged in the direction of the acting foreign body. The honeycombs are preferably closed in the longitudinal direction by a cover layer. The cell pressure distribution layer preferably comprises a rib or ridge, which still more preferably extends in the direction of an anticipated foreign body. The cell pressure distribution layer is preferably arranged on an outside of a frame, and still more preferably on the outside of a second frame element region. The cell pressure distribution layer is preferably arranged only in predetermined regions of the battery cell, and still more preferably in regions in which a risk from a foreign body having a particularly small end face is anticipated. A pressure cell distribution layer preferably extends beyond the associated battery cell. A cell pressure distribution layer is preferably designed to be electrically conducting at least on some regions, notably by means of a metallic coating and/or a metal wire.

According to the invention, a battery comprises two or more battery cells according to the invention, which are arranged parallel to each other and/or so as to be in contact with each other.

Preferably several second frame element regions of adjoining battery cells are designed as one piece and still more preferably comprises a pourable material and/or a fluid. The fluid is preferably viscous, wherein the viscosity of the fluid is adjusted to the anticipated velocity of the acting foreign body. The fluid can preferably be compressed.

The battery preferably comprises a relief device, which allows the fluid to leave the space it originally took up.

Still more preferably, the opening of the relief device is adjusted to the anticipated velocity of the acting foreign body. Preferably two battery cells are separated by a cell pressure distribution layer. Several battery cells are preferably electrically interconnected. Still more preferably several battery cells are connected in series to form a cell group. Several cell groups are preferably connected in parallel. Preferably two cell groups are separated by a cell pressure distribution layer.

The battery preferably comprises one, two, four or more connecting means, which connect the battery cells to each other and which embrace and/or enclose the battery cells. The connecting means is preferably designed as a metal clamp, screw assembly or peripheral strap.

The battery advantageously comprises two battery connecting devices or terminals, which in particular are used for the direct electrical connection to a load. Preferably two battery connecting devices are arranged on outside surfaces of the battery, and still more preferably on the same outside surface.

The cell pressure distribution layers of several adjoining battery cells of a battery are preferably designed as one piece. These preferably form an outside surface of the battery.

The battery comprises a battery pressure distribution layer at least in some regions. This layer is preferably arranged parallel to an outside surface of the battery, and still more preferably the battery pressure distribution layer forms an outside surface of the battery. A battery pressure distribution layer preferably comprises at least one material from the following group consisting of: ferruginous alloys, steel, lightweight metals such as aluminum, titanium or magnesium, plastic materials such as notably PP, PA or PE, which are in particular crosslinked and which are in particular reinforced with fillers and/or woven fabrics/laid scrims, notably containing carbon, glass and/or aramide fibers. A battery pressure distribution layer preferably has a honeycomb structure, still more preferably containing aramide fibers and/or a metal foil, wherein still more preferably the longitudinal axes of the honeycombs are arranged in the direction of the acting foreign body and act to reinforce the battery pressure distribution layer. A battery pressure distribution layer preferably comprises a rib or ridge, which still more preferably extends in the direction of an anticipated foreign body. A battery pressure distribution layer preferably has an undulated profile and/or corrugations, the longitudinal axes of which are arranged in the direction of the acting foreign body. A battery pressure distribution layer is preferably arranged in regions of the battery in which a risk by foreign bodies is anticipated. The battery preferably comprises several battery pressure distribution layers, which are arranged parallel to different delimiting surfaces of the battery cells, which still more preferably form the outside surfaces of the batteries. Preferably several battery pressure distribution layers are connected to each other. A battery pressure distribution layer is preferably arranged at a distance from the battery cells and leaves a space between the battery pressure absorption layer and a battery cell, notably the cell pressure distribution layer thereof. This space is preferably filled with a pourable or flowable substance, notably sand and/or glass particles, or a substance mixture. This space is preferably not filled and allows a deformation of a battery pressure absorption layer, without thereby coming in contact with a battery located beneath. A battery pressure distribution layer is preferably electrically conducting at least in some regions, notably by means of a metallic coating and/or a metal wire. The battery advantageously comprises one, two or more separation protection layers. An separation protection layer of the battery is preferably arranged between a battery pressure absorption layer and a battery cell or the frame thereof. The separation protection layer is preferably designed as a woven fabric or laid scrim, and still more preferably as a cut-resistant woven fabric, notably made of aramide fibers. Preferably several separation protection layers are arranged in regions of the battery in which action by foreign bodies is to be anticipated. An separation protection layer is preferably designed to be electrically insulating. An separation protection layer preferably has a lower yield point than a battery pressure distribution layer. The separation protection layer also acts corresponding to a second frame element region, in particular by distributing a force across a larger surface area and deflecting a force in the transverse direction to the direction of action of the foreign body.

The battery advantageously comprises one, two or more battery reinforcement components. A battery reinforcement component notably acts such that it distributes an acting force onto several battery pressure absorption layers. A battery reinforcement component notably acts such that an acting foreign body is stopped before striking a battery pressure absorption layer. A battery reinforcement component is preferably designed as a protective bracket or protective cage. A battery reinforcement component surrounding the battery preferably holds a battery pressure absorption layer or an separation protection layer at a distance from the battery. A battery reinforcement component is preferably connected to a battery connecting region.

The battery advantageously comprises at least one deformation component, which is notably provided to deform in a predetermined manner, notably due to an acting foreign body. Advantageously several deformation components act jointly to support a battery pressure absorption layer. A deformation component advantageously deforms while converting kinetic energy of a foreign body into deformation work. The deformation component is preferably arranged between a battery pressure absorption layer and a cell pressure absorption layer. The deformation component is preferably arranged on an outside surface of the battery. The yield point of the deformation component is preferably lower than the yield points of the adjoining battery pressure absorption layer and cell pressure absorption layer. The deformation component is preferably designed such that the cross-sectional surface area thereof decreases in the direction of an anticipated foreign body or the adjoining battery pressure absorption layer. The deformation component preferably has at least one axis of symmetry. The deformation component is preferably designed to be conical and/or have an opening angle, wherein the apexes thereof point toward the battery pressure absorption layer.

The battery advantageously comprises one, two to four, or more battery connecting regions. A battery connecting region is notably provided for the connection to an additional body, preferably a battery receiving device of a motor vehicle, a machine to be powered, or a system. A battery connecting region preferably comprises a mechanical connecting means or is designed for interaction with a mechanical connecting means. The mechanical connecting means preferably has a predetermined breaking point and is still more preferably designed as a notched pin or connector. A battery connection device or terminal is preferably arranged in a battery connecting region. When connecting the battery to an additional body, preferably an electrical connection is established at the same time between a battery connection device and an electrical device of the machine or system to be powered. To this end, the battery connection device is preferably designed as a protrusion having a predetermined breaking point, notably a notched pin or connector. The battery connecting region preferably transmits only a predetermined force. Taking the number of battery connecting regions into consideration, this predetermined force is selected for an anticipated acceleration of the battery or force acting on the battery, notably as a result of an accident.

A battery preferably comprises a cell contact device. The cell contact device is notably used to electrically connect the electrochemical energy storage devices to the battery connection devices. Two battery connection devices or terminal contacts of the battery are preferably connected to the cell contact device. The cell contact device is preferably designed in a substantially plate-shaped manner and extends parallel to an outside surface of the battery. The cell contact device is separated from the surroundings by a battery pressure distribution layer and/or separation protection layer. The cell contact device is preferably arranged in a region of the battery in which the action of a potentially damaging foreign body is not anticipated. The cell contact device is preferably designed as a printed circuit board. The cell contact device comprises two common terminals which are electrically connected to the battery connection devices. The common terminals and battery connection devices are preferably designed as one piece and still more preferably the battery connection devices are arranged on the cell contact device. A common terminal is preferably arranged as a plug-in or screw-on terminal, notably on a cell contact device designed as a printed circuit board. The cell contact device comprises at least two cell contact elements, notably for the connection to the current collectors of an electrochemical energy storage device or battery cell. The cell contact device preferably comprises a pair of cell contact elements for each battery cell. A cell contact element is preferably designed to be detachable, and still more preferably as a spring-loaded clamp. A cell contact element is preferably arranged on a cell contact device designed as a printed circuit board, and still more preferably it is soldered or welded on.

The cell contact device preferably comprises one, two or more current carrying devices, which are preferably designed as conductive tracks, strands, bus bars or flat cables. A current carrying device is used in particular to connect a cell contact element of a first battery cell to a cell contact element of a further battery cell and/or to a common terminal. Preferably a plurality of current carrying devices are designed for the series connection and/or parallel connection of battery cells. Preferably in particular four battery cells are connected in series by means of current carrying devices to form a cell group. Preferably several cell groups are connected in parallel and/or in series by means of current carrying devices. Preferably at least some current carrying devices are designed flat on the cell contact device. Preferably at least several current carrying devices are produced according to a photochemical method and/or in thick copper technology.

Preferably one or more current carrying devices are connected to one or more heat exchanger devices in a heat conducting manner. This heat exchanger device is preferably a heat sink and/or a device comprising fluid ducts which are in planar contact with at least one current carrying device and/or cell contact elements. A heat exchanger device is preferably separated from a current carrying device by a heat conducting, electrically insulating layer. The at least one heat exchanger device preferably extends through a cut-out in a battery pressure distribution layer or an separation protection layer. The at least one heat exchanger device is preferably arranged in a region of the battery in which the damaging action of a foreign body is not anticipated. Preferably several heat exchanger devices are connected to each other forming a common fluid duct, through which particularly preferably a coolant flows intermittently. A fluid preferably flows around or through the heat exchanger device.

The current path between a battery connection device and a battery cell advantageously comprises an interrupter device. This interrupted device is notably used to interrupt a current path, which contains a cell contact element, a current carrying device and/or a common terminal. Each current path preferably has a dedicated interrupter device. An interrupter device is preferably designed as a switch (transistor or relay), as an electrical conductor having a predetermined breaking point, or as a conductive track having a thin area.

An interrupter device is advantageously connected to one or more actuating devices. The actuating device is preferably designed as a pressure surface, inductive contact or capacitive contact. The actuating device is preferably arranged on the inside or outside of a battery pressure distribution layer or separation layer or adjacent thereto. An actuating device preferably protrudes through a cut-out in a battery pressure distribution layer or separation layer. An actuating device is preferably connected to several interrupter devices and actuates these jointly. An actuating device is preferably arranged in a region of the battery in which a damaging action of a foreign body is anticipated. Preferably several actuating devices are arranged on various outside surfaces of the battery, whereby at least one interrupter device is actuated independently of the direction of action of a damaging foreign body. An interrupter device and an actuating device are preferably designed as one piece. An actuating device preferably actuates a cell contact element such that the electrical connection thereof to a battery cell is interrupted. An actuating device preferably actuates a separating device such that a current collector of an electrochemical energy storage device is divided. An actuating device is preferably designed as a push button, shear body or notably as a push rod. An actuating device preferably acts on a predetermined breaking point of a battery connection device.

A separator that is used for the electrode stack of the electrochemical energy storage device is advantageously one which is not or poorly electron conducting and which is made of a carrier which is at least partially permeable to substances. The carrier is preferably coated with an inorganic material on at least one side. The at least partially substance-permeable carrier used is preferably an organic material, which is preferably designed as a nonwoven fabric. The organic material, which preferably comprises a polymer and still more preferably polyethylene terephthalate (PET), is coated with an inorganic, preferably ion conducting, material, which further preferably is ion conducting in a temperature range of −40° C. to 200° C. The inorganic material preferably comprises at least one compound of the group consisting of oxides, phosphates, sulfates, titanates, silicates, and aluminosilicates having at least one of the elements Zr, Al, Li, with zirconium oxide being particularly preferred. The inorganic, ion conducting material preferably comprises particles having a maximum diameter of less than 100 nm. Such a separator is sold, for example, under the trade name “Separion” by Evonik AG in Germany.

The use of such a conductor advantageously reduces the risk of a short circuit in an electrode stack of an electrochemical energy storage device.

Advantageously a motor vehicle is equipped with at least one motor vehicle connection device and a battery receiving device. These devices are designed as mating pieces to, and for interaction with, the battery connection devices and battery connecting regions. After inserting the battery in the battery receiving device, advantageously at least one battery connection device and one battery connecting region are connected to the respective mating pieces of the motor vehicle.

In a battery connecting region, preferably a mechanical connecting means and a battery connection device are arranged in spatial proximity to each other. Preferably one or two battery connection devices provided with predetermined breaking points project in particular downwardly out of the battery and into, notably upwardly open, motor vehicle connection devices. A mechanical connecting means and a battery connection device are preferably designed coaxially. A battery connection device is preferably designed as a sleeve so as to receive a bolt or pin of the motor vehicle and/or a screw or rivet, the respective diameters of which are smaller than the bores of the sleeve. The mechanical connecting means is preferably fed through the battery connection device. The mechanical connecting means preferably comprises a predetermined breaking point. A displacement of the battery preferably causes the predetermined breaking point of the battery connection device to fail. Preferably one or two battery connection devices pass through a respective battery connecting region. The mechanical connection between the motor vehicle and a battery connecting region is preferably designed such that a predetermined acceleration or force, notably in the horizontal direction, for example during an accident of the motor vehicle, results in failure of this mechanical connection. The ensuing displacement of the battery advantageously brings about a failure of a predetermined breaking point of at least one battery connection device.

A method according to the invention for operating a battery is characterized in particular by the actuation of an actuating device, notably by a force. The actuating device is actuated by a foreign body acting on the battery and/or by a component of the motor vehicle. An actuating device, which is notably arranged on an outside surface of the battery, at least comes in contact with a foreign body before the foreign body can penetrate the space occupied by the battery. To the extent that the foreign body subsequently in fact penetrates the space occupied by the battery, the battery is no longer able to deliver electrical power. The same applies when a vehicle component threatens to penetrate the space occupied by the battery or the battery has left the originally occupied space and strikes a component of the motor vehicle. The actuating device advantageously acts on an interrupter device and interrupts a current path. The actuating device preferably acts on a separating device for dividing a current collector, on a predetermined breaking point of a battery connection device for the failure thereof and/or on a predetermined breaking point of a current carrying device for the destruction thereof.

A method for operating a battery according to the invention is advantageously characterized in that initially a first force is exerted on the battery. For example, a foreign body or a component of the motor vehicle exert this first force on the battery. This first force optionally exceeds a predetermined force, which is selected depending on anticipated forces. As a result of this predetermined force being exceeded, the at least one battery connecting region moves away from the intended place in the motor vehicle. This displaces the battery. According to the invention, at least one of the battery connection devices fails as a result of the displacement of the battery. For this purpose, the battery connection device is designed with a predetermined breaking point. Preferably the at least one battery connection device breaks, or the electrical connection to the battery cells is interrupted, in particular by a power cable or strand being torn. The at least one battery connection device preferably breaks out of the combination of the battery.

A cell pressure distribution layer and a battery pressure distribution layer advantageously act jointly as a capacitor. To this end, the cell pressure distribution layer forms the first capacitor plate and the battery pressure distribution layer forms the second capacitor plate. An separation protection layer advantageously acts as a dielectric between these capacitor plates. The pressure distribution layers, or capacitor plates, preferably have different electrical charges Q and a potential difference ΔU. The capacitor plates are preferably intermittently connected to a voltage source. Still more preferably a cell pressure distribution layer and a battery pressure distribution layer are intermittently electrically connected to one or more battery cells of the battery. After application of the electrical charges Q, this electrical connection is disconnected again. The electrical charge of the capacitor plates is preferably refreshed at predetermined times. A measuring device advantageously measures the potential difference ΔU at predetermined points in time. The potential is also calculated:

$$Δ U = \frac{Q \cdot {x}_{0}}{{ɛ}_{0} \cdot ɛ \cdot A}$$

Here, x₀ denotes the plate distance, A is a plate surface, and ∈ is the dielectric constant of the separation protection layer. A control device is used to calculate the potential difference and preferably likewise carries out the charging and/or refreshing of the charge of the pressure distribution layers or capacitor plates. The control device also compares the calculated potential difference to the measured potential difference. The battery management system preferably provides the functions of this control device. To the extent that the calculated potential difference deviates from the measured one, a change in the plate capacitor can be concluded. A change in the plate capacitor is preferably concluded from different time curves between the calculated and measured potential differences. In this way, a leakage current, which in practice cannot always be avoided, between the capacitor plates is taken into account. A deformation of the components involved, notably of the outer battery skin, can be concluded from the change of a current/active measured potential difference or time curve of the measured potential difference.

Further advantages, characteristics, and application options of the present invention will be apparent from the following description in connection with the figures. In the drawings:

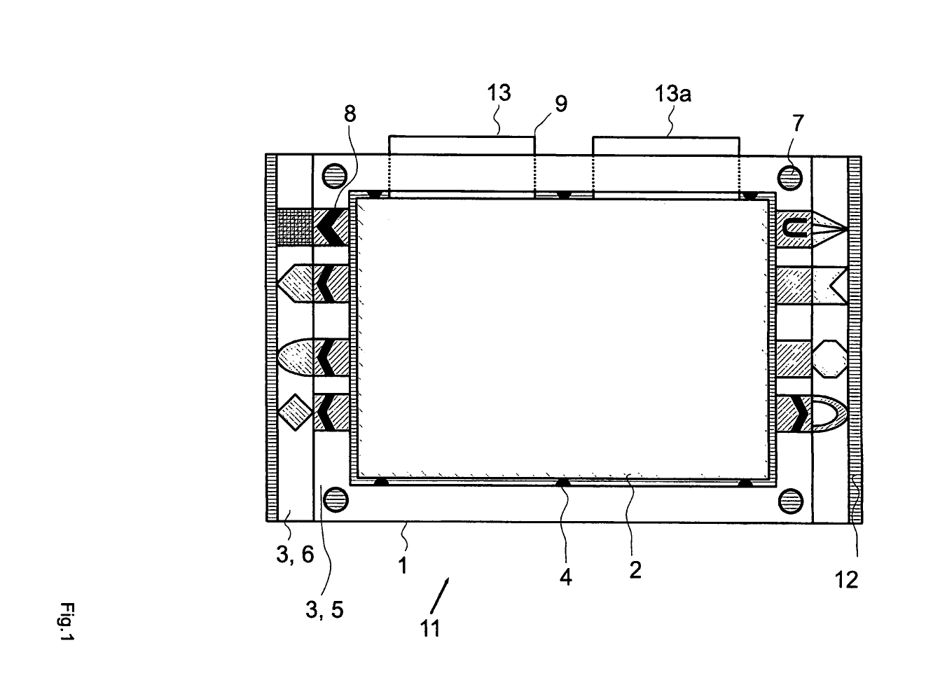

FIG. 1 is a frame according to the invention comprising first and second frame element regions with an inserted electrochemical energy storage device;

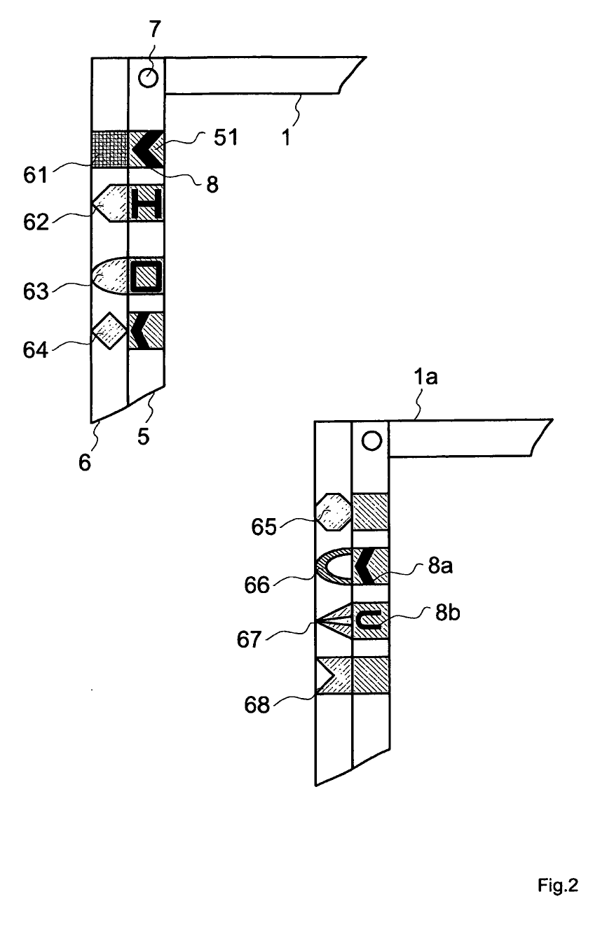

FIG. 2 is a frame according to the invention comprising first and second frame element regions and various embodiments of these frame element regions;

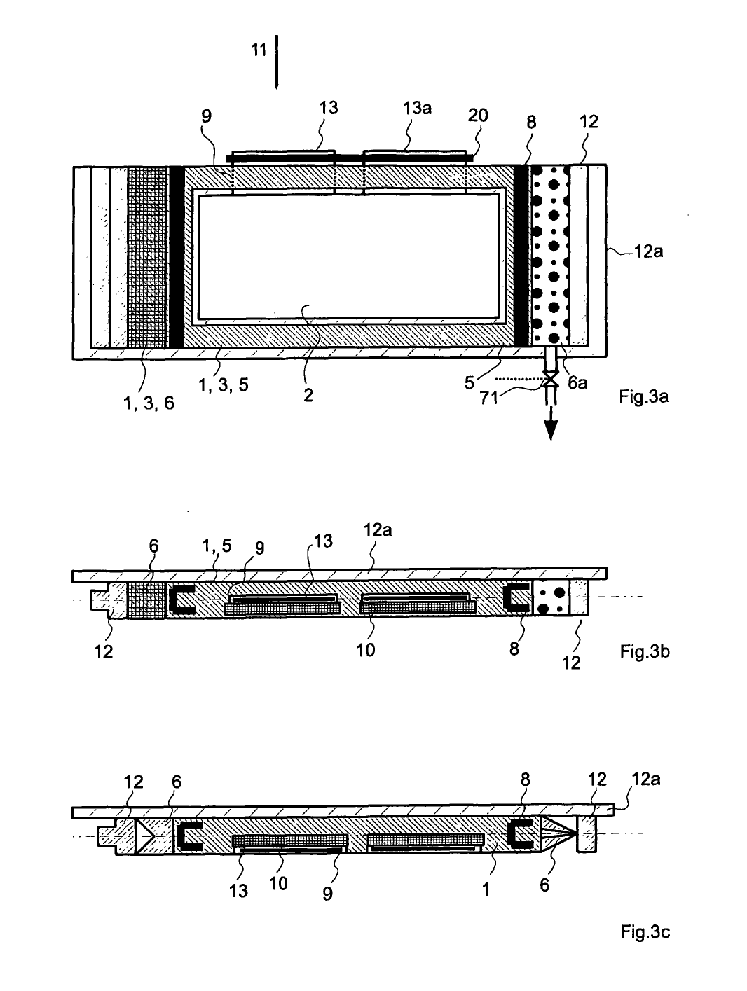

FIG. 3 shows an open battery cell according to the invention with a cut frame, wherein a second frame element region comprising a flowable material is provided;

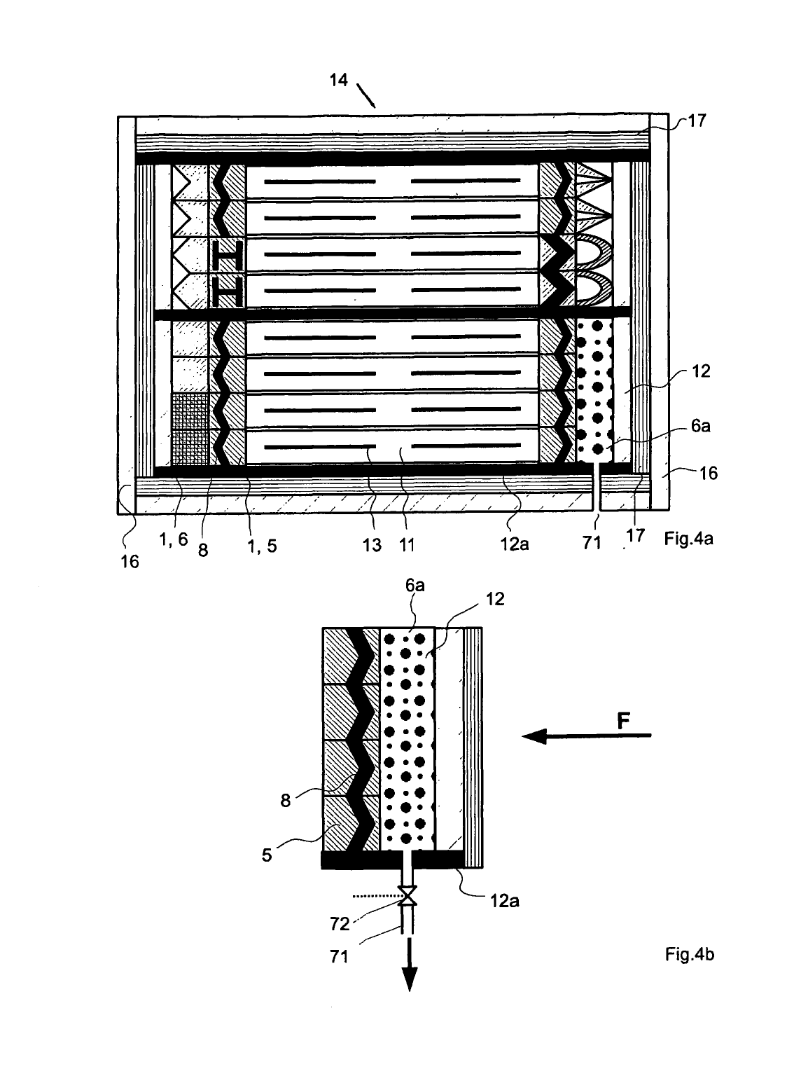

FIG. 4 is a partial section of a battery according to the invention comprising a plurality of battery cells;

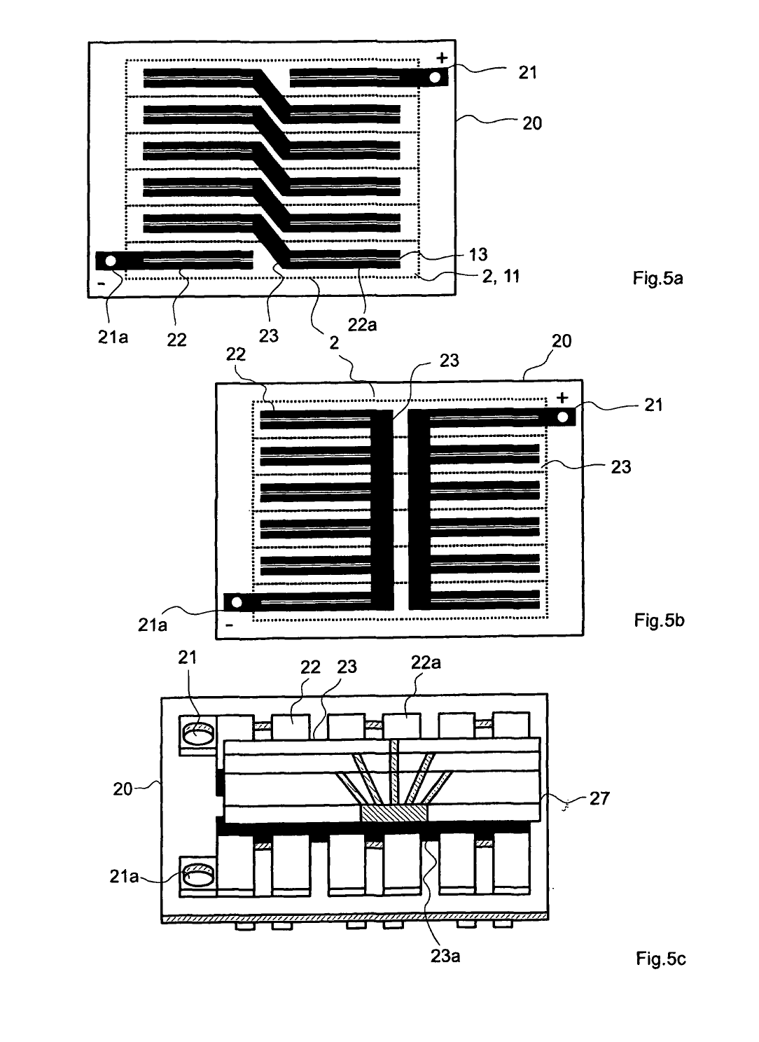

FIG. 5 is a cell contact device according to the invention, including an attached heat exchanger device;

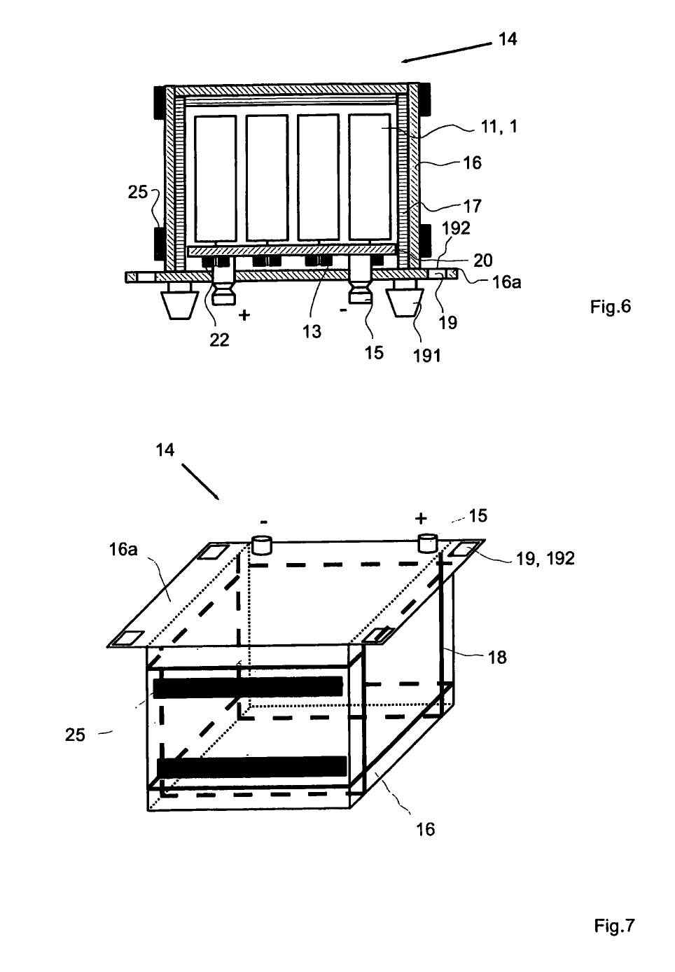

FIG. 6 is a partial section of a battery according to the invention comprising a cell contact device, battery connection devices with predetermined breaking points and battery connecting regions for the connection to a battery receiving device of a motor vehicle; and

FIG. 7 is a perspective view of a battery according to the invention comprising battery connection devices, battery reinforcement components, battery connection devices and battery connecting regions.

FIG. 1 shows a frame 1 according to the invention comprising first 5 and second 6 frame element regions of a frame element 3 having an inserted electrochemical energy storage device 2. The frame 1 comprises several integrally molded spacers 4, which support the electrochemical energy storage device 2 to prevent displacement inside the frame 1. The frame 1 further comprises a frame cut-out 9, which is implemented in the upper horizontal frame element and the non-visible edges of which are shown by perpendicular lines indicated by dashes. A current collector 13 of the electrochemical energy storage device 2 passes through the frame cut-out 9. Each of the vertical frame elements 3 comprises a first frame element region 5 and a second frame element region 6, wherein the yield point of the second frame element region 6 is lower than the yield point of the first frame element region 5. The first frame element regions 5 are produced from a fiber composite material and comprise respective metallic inserts 8 as the frame reinforcement components. The second frame element regions 6 are produced from an elastomer. The two frame element regions 5, 6 also differ in terms of the shapes of the cross-sections. Several examples are folded into the drawing plane. The frame 1 comprises a frame connecting region 7 having bores through which threaded rods pass. A cell pressure distribution layer 12 is shown in a horizontally hatched manner. This layer is designed as support against a battery pressure distribution layer, which is not shown, and protrudes beyond the second frame element regions 6. The covers of the frame opening are missing to provide a better illustration of the remaining components of the frame cell 11.

FIG. 2 is a schematic view of parts of a frame 1 according to the invention, comprising a respective first 5 and second 6 frame element region. Various cross-sections of the frame element regions 5, 6 are folded into the drawing plane. A first cross-section 51 of the first frame element region 5 has a square shape and encloses an insert 8, the yield point of which is higher than the yield point of the first frame element region 5. The insert 8 has a reinforcing effect both due to the cross-section thereof and due to the material thereof. Various inserts 8, 8a, 8b having preferred profiles are shown. The second frame element region 61 is produced from rigid foam, notably from metal foam, PS foam or PU foam. A foreign body optionally penetrates the foam at least partially and compresses the same, wherein kinetic energy of the foreign body is converted. The second frame element regions 62, 63, 64, 65 and 68 react to a penetrating foreign body with energy-absorbing deformation in the direction of movement of the foreign body and with transverse strain. The transverse strain causes the second frame element regions 6 of adjoining frames to act jointly to decelerate the foreign body. Moreover, the action of the penetrating body is distributed across a larger surface area. The second frame element regions 66, 67 enclose a respective hollow space, which is filled with a compressible fluid. In this way, adjacent second frame element regions 6 cooperate for a large-surface-area distribution of the foreign body action. The second frame element regions 6 having the cross-sections 63, 67 are characterized by decreasing wall thicknesses in the direction of an anticipated foreign body. A penetrating foreign body is thus exposed to increasing resistance.

FIG. 3a shows an open battery cell 11 according to the invention comprising a flowable second frame element region 6a. An electrochemical energy storage device 2 is surrounded by a frame 1 having first 5 and second frame element regions 6, 6a. The frame 1 has a frame cut-out 9 through which a current collector 13, 13a extends. The first frame element region 5 comprises a profiled insert 8. The battery cell 11 is surrounded by a cell pressure distribution layer 12 and another cell pressure distribution layer 12a. The cell pressure distribution layer 12a extends beyond the cell pressure distribution layer 12 and is used to support a battery pressure distribution layer, which is not shown. The cell pressure distribution layer 12a preferably comprises ribs or ridges to prevent the layer from buckling. The yield point of the insert 8 is higher than the yield point of the first frame element region 5. The yield point of the first frame element region 5 is higher than the yield point of the second frame element region 6, 6a. The yield points of the cell pressure absorption layers 12, 12a are likewise higher than the yield point of the second frame element region 6, 6a. The second frame element region 6a is composed of a fluid. This second frame element region 6a is enclosed by the surrounding components such that the fluid cannot escape uncontrolled. Advantageously the viscosity of the second frame element region 6a is selected such that the fluid exits through the capillary opening 71 above a predetermined force. The capillary opening 71 is preferably closed by a valve, which still more preferably is opened as needed by a battery management system, which is not shown, or by a higher-level controller of the motor vehicle. The second frame element region 6 is implemented as metal foam. A cell contact device 20 is connected to the current collectors 13, 13a.

FIG. 3b shows the battery cell of FIG. 3a from a different viewing angle. FIG. 3b shows the profiling of the inserts 8, the positions of the frame cut-out 9 along an axis of symmetry of the frame 1 and the separating device 10.

FIG. 3c shows a modification of the battery cell 11 of FIGS. 3a and 3b. The second frame element regions 6 are produced from an elastomer. The frame opening 9 is arranged in an edge region of the frame 1. The separating device 10 adjacent to the frame opening 9 is located in the vicinity of an axis of symmetry of the frame 1. A current collector 13 of the electrochemical energy storage device 2 passes through the frame cut-out 9. The cross-sections of the second frame element regions 6 are selected such that the wall thicknesses thereof decrease in the direction of an anticipated foreign body. Compressible fluids are also provided in the cut-outs of the cross-sections.

FIG. 4a shows a detail of a battery 14 according to the invention comprising several battery cells 11. The outer skin of the battery 14 is formed by battery pressure distribution layers 16. Separation protection layers 17 are arranged on the insides. The yield points of the separation protection layers 17 are considerably lower than those of the battery pressure distribution layers 16. Moreover, the separation protection layers 17 are designed to be compressible and deformable to a certain degree. The separation protection layers 17 are designed as woven aramide fabric. Cell pressure distribution layers 12, 12a abut the insides of the separation protection layers 17. The yield points thereof correspond approximately to the yield points of the battery pressure distribution layers 16. The figure shows various embodiments of a frame 1 comprising differing first 5 and second 6 frame element regions and inserts 8. The properties of the individual frame element regions 5, 6 are described in the explanations for FIGS. 2 and 3. The capillary 71 projects through the cell pressure distribution layer 12a, separation protection layer 17 and battery pressure distribution layer 16. The capillary 71 allows the fluid of the second frame element region 6a to exit, notably while converting kinetic energy of a foreign body as a result of fluidic friction inside the capillary 71. A feature of the second element region 6a is that several individual second element regions 6 of differing frames 1 are combined to form a common region.

FIG. 4b shows an enlarged detail of FIG. 4a and the direction of action of a foreign body on a cell pressure distribution layer 12. It also shows that the capillary 71 can be closed by a controllable valve 72.

FIG. 5a shows a cell contact device 20 according to the invention. Shown in dotted fashion are the electrochemical energy storage devices 2 or battery cells 11 located underneath. The cell contact device 20 comprises two common terminals 21, 21a. These are advantageously integrally molded on the cell contact elements 22, 22a. Pairs of cell contact elements 22 are connected to each other by a respective current carrying device 23. In this way, a series connection of the dotted electrochemical energy storage devices 2 or battery cells 11 is achieved. A current collector 13 is contacted by means of the cell contact element 22a. In the present example, the cell contact device 22 is designed as a multiplex circuit board. The current carrying devices 23 are designed as conductive tracks. The cell contact elements 22 are soldered onto these conductive tracks. The common terminals 21, 21a comprise through-holes for screwing on a connecting cable or a battery terminal. The battery connection devices or battery terminals, which are not shown, are preferably designed as pins comprising predetermined breaking points and pass through the bores of the common terminals 21, 21a. In a further advantageous embodiment, the battery connection devices are connected to the common terminals 21, 21a by means of short cables. Upon actuation, an actuating device 25, which is not shown, folds this connecting cable between the common terminal 21 and a battery connection device which is not shown. In a further advantageous embodiment, an actuating device 25 acts directly on a, notably spring-loaded, cell contact element 22 and opens the same. In a further advantageous embodiment, the actuating device 25 acts directly on the entire cell contact device 20 and displaces the same out of the usual position. In the process, at least several current collectors 13 leave the associated cell contact elements 22.

FIG. 5b shows a further embodiment of a cell contact device 20. The current carrying devices 23 connect the cell contact devices 22 to form a parallel connection of the dotted electrochemical energy storage device 2 or battery cells 11.

FIG. 5c shows a cell contact device 20 in a perspective view. This cell contact device 20 is also designed as a printed circuit board. The cell contact device 20 comprises common terminals 21, 21a having through-bores, several cell contact elements 22, 22a and several current carrying devices 23, 23a (shown in black). A heat exchanger device 27 is also shown, which here is a ribbed heat sink made of aluminum, the cross-section of which is folded into the drawing plane. The heat sink 27 is connected to the current carrying devices 23, 23a. For greater visibility of the conductive tracks located underneath, the heat sink 27 is shown shortened.

FIG. 6 is a schematic illustration of a sectional view of a battery 14 according to the invention. The battery comprises several battery cells 11. These are shown in a side view only as blocks comprising a current collector 13 extending therefrom. The current collectors 13 are electrically connected by means of cell contact elements 22 of the cell contact device 20. Moreover, battery connection devices 15 are connected to the cell contact device 20. These have a respective predetermined breaking point, which is designed as a peripheral notch. The battery connection devices 15 project, for example in an electrically insulated manner, through bores of a battery pressure distribution layer 16a. This battery pressure distribution layer 16a additionally comprises two battery connecting regions 19. The mechanical connecting means of the battery connecting region 19 is a notched centering pin 191 and a through-bore 192. The battery connection device 15 is also arranged in the battery connecting region 19. The battery connecting regions 19 cooperate with corresponding devices of a motor vehicle for the mechanical connection, and in particular for the electrical connection. The outer skin of the battery 14 is formed by battery pressure distribution layers 16. These are arranged adjacent to the separation protection layers 17. The details of the battery cells 11 or of the frames 1 thereof are not shown. The connecting pins 191 and the battery connection devices 15 are dimensioned such that a higher shear force is required for the failure of the predetermined breaking point of the connecting pin 191 than for the failure of the predetermined breaking point of the battery connection device 15. Advantageously, the battery 14 is held positively and/or by force fit in the region of the battery pressure distribution layer 16a. Clamping levers which act on the battery pressure distribution layer 16a and allow fast replacement of the battery 14 are advantageous for clamping the battery 14. Because of the conical design of the connecting pins 191, the battery connection devices 15 are threaded in corresponding mating pieces when the battery 14 is inserted in the motor vehicle. The battery 14 also comprises several actuating devices 25. These actuating devices 25 are designed as pressure surfaces along select outside surfaces of the battery 14. The battery devices 25 actuate interrupter devices 24 in the interior of the battery 14, which are not shown.

FIG. 7 shows a perspective view of a battery 14 according to the invention comprising battery connection devices 15, battery reinforcement components 18, battery connection devices 15 and battery connecting regions 19. The outer skin of the battery 14 is formed by several battery pressure distribution layers 16, 16a. The battery reinforcement component 18 is designed as a protective cage.

The battery reinforcement component 18 is arranged at a distance from the battery pressure distribution layers 16, however is connected to the battery pressure distribution layers 16a in several battery connecting regions 19. In an embodiment that is not shown, the battery reinforcement component 18 holds the several battery pressure distribution layers 16, 16a. Actuating devices 25, which are designed as pressure plates, are arranged on the surface of a battery pressure distribution layer 16. These are connected to interrupter devices, which are not shown, and cell contact elements in the interior of the battery 14. It is not shown that the actuating devices 25 are arranged in the regions of corners of the battery 14 which during the displacement of the battery advantageously come in contact with auto body parts first.

1. A frame for an electrochemical energy storage device, the frame being provided to surround the electrochemical energy storage device at least in some regions, the frame comprising:
a frame element, which includes a first frame element region having a first yield point,
wherein a quotient of the yield points of the second frame element region and of the first frame element region is below a predetermined value and a cell pressure distribution layer is configured to be arranged at a predetermined first distance from the frame.

2. The frame according to claim 1, wherein
the first frame element region is arranged adjacent to the second frame element region,
the frame comprises a frame connecting region configured to connect the frame to an additional body,
the frame comprises a frame reinforcement component including a yield point that is higher than the second yield point, and/or
the frame comprises a frame cut-out including separating device arranged adjacent to the frame cut-out.

3. A battery cell comprising a frame according to claim 1 comprising:
an electrochemical energy storage device,
wherein a current collector of the electrochemical energy storage device is fed through a frame cut-out.

4. A battery comprising two or more battery cells according to claim 3, wherein the two or more battery cells are arranged parallel to each other,
the battery includes a battery connection device configured to connect to a load, and
the battery connection device is arranged in a region of an outside surface of the battery.

5. The battery according to claim 4, wherein
the battery comprises a battery pressure distribution layer arranged parallel to an outside surface of the battery at a predetermined second distance,
the battery comprises an separation protection layer arranged adjacent to a frame element,
the battery comprises a battery reinforcement component including a yield point which is higher than the second yield point,
the battery comprises a deformation component configured to deform in a predetermined manner, and/or
the battery comprises at least one battery connecting region configured to connect to an additional body, wherein the battery connection device is arranged in the battery connecting region.

6. A battery according to claim 4, comprising:
a cell contact device configured to electrically connect an electrochemical energy storage device to a battery connection device, wherein the cell contact device comprises:
two common terminals, each configured to electrically connect to a battery connection device,
two cell contact elements configured to electrically connect to a battery cell or an electrochemical energy storage device thereof,
a current carrying device configured to electrically connect a cell contact element to a further cell contact element and/or a common terminal,
wherein the current carrying device is connected to a heat exchanger device in a heat conducting manner, around or through a fluid flows.

7. A battery (14) according to claim 4, comprising:
two cell contact elements;
a common terminal;
a current carrying device;
an interrupter device configured to electrically insulate a cell contact element and/or a common terminal and/or to interrupt a current carrying device; and
an actuating device configured to actuate the interrupter device, wherein the actuating device is arranged adjacent to an outside surface of the battery.

8. A battery according to claim 4, wherein an electrochemical energy storage device comprises at least one separator, which is not or only poorly electron conducting and which is made of an at least partially substance-permeable carrier,
wherein the carrier is coated on at least one side with an inorganic material, the at least partially substance-permeable carrier is an organic material designed as a non-woven fabric,
wherein the organic material comprises a polymer including a polyethylene terephthalate (PET), the organic material is coated with an inorganic, ion conducting material, the ion conducting material is ion conducting in a temperature range of −40° C. to 200° C.,
wherein the inorganic material comprises at least one of oxides, phosphates, sulfates, titanates, silicates, aluminosilicates having at least one of the elements Zr, Al or Li, and zirconium oxide, and
wherein the inorganic ion conducting material comprises particles having a maximum diameter of less than 100 nm.

9. A motor vehicle comprising a battery according to claim 4, comprising:
a motor vehicle connection device configured to electrically connect, which is to a battery connection device,
wherein at least one battery connecting region is connected to the motor vehicle by force fit and/or positively,
a battery connection device is arranged in the battery connecting region, and
the battery connection device is connected to the motor vehicle connection device in an electrically conductive manner.

10. A method for operating a battery according to claim 6, comprising:
actuating the actuating device;
actuating the interrupter device by the actuating device; and
insulating a cell contact element and/or a common terminal and/or interrupting a current carrying device by the interrupter device.

11. A method for operating a battery according to claim 7, comprising:
exerting a first force on the battery, the first force exceeding a predetermined force; and
displacing the battery, wherein a battery connection device fails.

12. A method for operating a battery according to claim 5, wherein a cell pressure distribution layer and a battery pressure distribution layer are spaced from each other by an separation protection layer, wherein the cell pressure distribution layer and the battery pressure distribution layer are designed to be electrically conducting at least in some regions and the separation protection layer is designed to be electrically insulating in some regions, and wherein the cell pressure distribution layer and a battery pressure distribution layer have differing electrical potentials, the method comprising:
measuring an electrical voltage between the two pressure distribution layers at predetermined points in time;
storing the measured electrical voltage; and
comparing measured electrical voltages of different points in time to each other.
